(19) United States
(12) Patent Application Publication
(10) Pub. No.: US 2013/0141409 A1
(43) Pub. Date: Jun. 6, 2013

(54) GAMMA CORRECTION METHOD

(71) Applicant: Tanahashi Kosei, Cheonan-si (KR)

(72) Inventor: Tanahashi Kosei, Cheonan-si (KR)

(21) Appl. No.: 13/466,566

(22) Filed: May 8, 2012

(30) Foreign Application Priority Data
Dec. 1, 2011 (KR) 10-2011-0127717

(51) Int. Cl. G09G 3/36; G09G 5/02; G09G 5/10

(52) U.S. Cl. 345/207; 345/690; 345/102; 345/88; 345/89

(57) ABSTRACT

A gamma correction method includes displaying a reference pattern on a panel, acquiring first luminance information including a luminance value of each point of the panel by taking an image of the panel using a surface distribution luminance meter, acquiring first correction luminance information by comparing the first luminance information with average luminance information, displaying a gradation pattern on the panel, acquiring second luminance information by taking an image of the panel using the surface distribution luminance meter, correcting and standardizing the second luminance information based on the first correction luminance information, and obtaining a gamma curve from the gradation pattern having the corrected second luminance information.

### CROSS-REFERENCE TO RELATED APPLICATION

This application claims priority to Korean Patent Application No. 10-2011-0127717 filed in the Korean Intellectual Property Office on Dec. 1, 2011, the entire contents of which are incorporated by reference herein.

### TECHNICAL FIELD

Embodiments of the present invention relate to a gamma correction method.

### DISCUSSION OF THE RELATED ART

Liquid crystal display (LCD) devices, plasma display panel (PDP) devices, light emitting display (LED) devices, or other flat panel display (FPD) devices, which are lightweight and thin and have low power consumption, have been replacing existing cathode ray tube (CRT) displays.

LCD devices, which are not self-emissive displays, include a backlight device. Panel suppliers may show the quality of the panels supplied to customers, e.g., backlight device manufacturers, by providing a gamma curve. A spot luminance meter is used to measure luminance values of a panel depending on gray level, thereby obtaining a gamma curve.

However, since this method repeats output and measurement for each and every gray level, it takes too long to obtain the gamma curve. The gamma curve obtained by an outside source (e.g., a panel manufacturer) may be different from a gamma curve obtained after the panel and backlight device are assembled together.

### SUMMARY

Embodiments of the present invention provide a gamma correction method that can measure luminance of a panel displaying a gradation pattern using a surface distribution luminance meter.

An exemplary embodiment of the present invention provides a gamma correction method including displaying a reference pattern on a panel being tested, acquiring first luminance information including luminance of each point of the panel being tested by imaging the panel being tested on which the reference pattern is displayed by using a surface distribution luminance meter, acquiring first correction luminance information by comparing the first luminance information with average luminance information, displaying a gradation pattern on the panel being tested, acquiring second luminance information by imaging the panel being tested on which the gradation pattern is displayed by using the surface distribution luminance meter, correcting and standardizing the second luminance information based on the first correction luminance information, and obtaining a gamma curve from the gradation pattern having the corrected second luminance information.

The gradation pattern includes a minimum gray level to a maximum gray level.

The gradation pattern includes 0th to 255th gray levels.

The panel being tested is placed on a backlight device for testing.

The gamma correction method further includes acquiring second correction luminance information by comparing spectrum information of the panel being tested by the backlight device for testing with spectrum information of the panel being tested previously measured by a backlight device from a backlight device manufacturer, correcting the gradation pattern having the corrected second luminance information based on the second correction luminance information, and obtaining the gamma curve from the gradation pattern corrected by the second correction luminance information.

The backlight device for testing and the backlight device provided from the backlight device manufacturer have different color characteristics.

When displaying the reference pattern on the panel being tested, a pattern generator is used.

According to the exemplary embodiments of the present invention, the method includes measuring the luminance of the panel, which displays the gradation pattern, by using the surface distribution luminance meter and correcting the measured luminance based on information relating to a change of luminance, which may occur due to stains, thereby quickly obtaining a gamma curve.

### BRIEF DESCRIPTION OF THE DRAWINGS

FIG. 1 is a flowchart illustrating a gamma correction method according to an exemplary embodiment of the present invention.

### DETAILED DESCRIPTION OF THE EMBODIMENTS

Hereinafter, the exemplary embodiments of the present invention will be described in detail with reference to the accompanying drawing. The present invention may be embodied in various different ways and should not be construed as limited to the exemplary embodiments described herein.

As used herein, the singular forms, “a”, “an”, and “the” are intended to include the plural forms as well, unless the context clearly indicates otherwise.

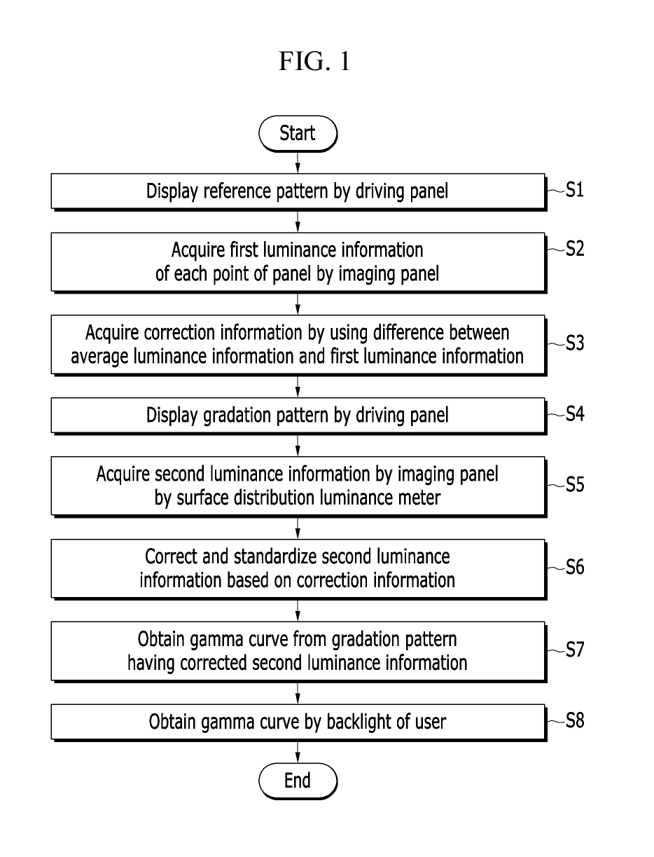

FIG. 1 is a flowchart illustrating a gamma correction method according to an exemplary embodiment of the present invention.

Referring to FIG. 1, a panel being tested is connected to a pattern generator which is in turn driven to display a reference pattern on the panel being tested (S1).

The panel being tested is in a semi-finished product state in which display elements, such as thin film transistors, are formed on a substrate but a backlight device is not yet assembled. For example, the panel being tested is placed on a backlight device for testing which is not for its commercial use, and the pattern generator is operated such that the panel being tested makes “plain display” at a gray level. As used herein, the phrase “plain display” refers to displaying an image with the same gray level over the entire panel being tested. The panel being tested performs the plain display at a predetermined gray level and displays a reference pattern. The pattern generator is a pattern input device that enables the panel being tested to display an image.

Next, an image is taken by the surface distribution luminance meter of the panel being tested displaying the gray level of an image, and first luminance information including luminance values of respective points on the panel is acquired (S2).

The surface distribution luminance meter simultaneously measures luminance values of all of the points on a panel surface. The measured luminance values may be different from each other due to stains on the panel or backlight, optical aberrations, or the like. The first luminance information includes the different luminance values for the respective points of the panel being tested. For example, the first luminance information includes a luminance distribution reflecting the influence by, e.g., stains.

Then, correction information is acquired by using a difference between average luminance information and the first luminance information (S3).

The average luminance information includes an average value of the entire luminance values included in the first luminance information. Differences between an average luminance value and the luminance values of the respective points are calculated. The correction information is obtained based on the calculated differences between the average luminance value and the luminance values of the points.

Then, the panel generator is operated so that the panel being tested displays a gradation pattern varying from a minimum gray level to a maximum gray level (S4).

For example, the gradation pattern includes 0th to 255th gray level.

Next, an image is taken by the surface distribution luminance meter of the panel being tested on which the gradation pattern is displayed so that second luminance information is obtained (S5).

The second luminance information includes luminance values which are represented by a gradation pattern in a panel manufacturing site before the second luminance information is corrected. The luminance values represented by the gradation pattern may vary depending on position on the panel, for example due to stains of the panel.

Next, the second luminance information is corrected and standardized based on the correction information obtained based on the difference between the first luminance information and the average luminance information (S6).

Next, a gamma curve is obtained from the gradation pattern having the corrected second luminance information (S7).

The corrected gradation pattern has corrected luminance values of respective grays, and the gamma curve is obtained from the corrected gradation pattern.

As described above, it is possible to simultaneously measure the luminance values of the respective points on the panel by using the surface distribution luminance meter using the gamma correction method. Therefore, the time taken to obtain a gamma curve is shortened.

The backlight device generally has different luminance intensity for each wavelength depending on characteristics of a lamp. Further, since a wavelength distribution of light transmitted through the panel is determined by color filters, as the type of the backlight device changes, color characteristics may vary. In this sense, according to an exemplary embodiment, the method may include an additional step (S8).

A gamma curve is obtained by using a backlight device provided from, for example, an outside source, such as a backlight device manufacturer (S8).

As used herein, the backlight device provided from the backlight device manufacturer refers to a backlight device which is not the backlight device for test but is actually assembled with a complete panel. Color characteristics of light that is emitted from the backlight device for test and passes through the panel being tested are compared with color characteristics of light that is emitted from the backlight device provided from the backlight device manufacturer and passes through the panel being tested to thereby calculate spectrum differences according to differences in the color characteristics.

A luminance correction value is obtained from the spectrum difference, and the gamma curve obtained by the corrected gradation pattern in step S7 is corrected again by the luminance correction value. Accordingly, a gamma curve for the backlight device provided from the backlight device manufacturer is obtained.

While the exemplary embodiments of the invention have been described, it is to be understood that the embodiments of the invention are not limited thereto, but on the contrary, intended to cover various modifications and equivalent arrangements included within the spirit and scope of the appended claims.

What is claimed is:

1. A gamma correction method, comprising:
displaying a reference pattern on a panel;
acquiring first luminance information including a luminance value of each point on the panel by taking an image of the panel using a surface distribution luminance meter;
acquiring first correction luminance information by comparing the first luminance information with average luminance information;
displaying a gradation pattern on the panel;
acquiring second luminance information by taking an image of the panel on which the gradation pattern is displayed, using the surface distribution luminance meter;
correcting and standardizing the second luminance information based on the first correction luminance information; and
obtaining a gamma curve from the gradation pattern having the corrected second luminance information.

2. The gamma correction method of claim 1, wherein the gradation pattern includes a minimum gray level to a maximum gray level.

3. The gamma correction method of claim 1, wherein the gradation pattern includes 0th to 255th gray levels.

4. The gamma correction method of claim 3, wherein the panel is placed on a backlight device for testing.

5. The gamma correction method of claim 4, further comprising:
acquiring second correction luminance information by comparing spectrum information of the panel obtained by the backlight device for testing with spectrum information of the panel previously measured by a backlight device provided from an outside source;
correcting the gradation pattern having the corrected second luminance information based on the second correction luminance information; and
obtaining the gamma curve from the gradation pattern corrected by the second correction luminance information.

6. The gamma correction method of claim 5, wherein the backlight device for testing and the backlight device provided from the outside source have different color characteristics.

7. The gamma correction method of claim 1, wherein the panel is placed on a backlight device for testing.

8. The gamma correction method of claim 7, further comprising:
acquiring second correction luminance information by comparing spectrum information of the panel obtained by the backlight device for testing with spectrum information of the panel previously measured by a backlight device provided from an outside source;
correcting the gradation pattern having the corrected second luminance information based on the second correction luminance information; and
obtaining the gamma curve from the gradation pattern corrected by the second correction luminance information.

9. The gamma correction method of claim 8, wherein the backlight device for testing and the backlight device provided from the outside source have different color characteristics.

10. The gamma correction method of claim 1, wherein the reference pattern is displayed on the panel by using a pattern generator.

11. A gamma correction method, comprising:
obtaining first luminance information from a reference pattern using a surface distribution luminance meter, wherein the reference pattern is displayed on a panel assembled with a first backlight device;
obtaining correction information based on differences between the first luminance information and average luminance information, wherein the average luminance information includes an average value of luminance values included in the first luminance information;
obtaining second luminance information from a gradation pattern having one or more gray levels using the surface distribution luminance meter, wherein the gradation pattern is displayed on the panel;
correcting the second luminance information based on the correction information; and
obtaining a gamma curve based on the corrected second luminance information.

12. The gamma correction method of claim 11, further comprising:
obtaining a spectrum difference between light passing through the panel assembled with the first backlight device and light passing through the panel assembled with a second backlight device;
obtaining a luminance correction value based on the spectrum difference; and
correcting the first gamma curve based on the luminance correction value.

13. The gamma correction method of claim 11, wherein the gradation pattern includes a minimum gray level to a maximum gray level.

14. The gamma correction method of claim 13, wherein the minimum gray level includes a 0th gray level, and the maximum gray level includes a 255th gray level.

15. The gamma correction method of claim 12, wherein the first backlight device and the second backlight device have different color characteristics.

16. The gamma correction method of claim 12, wherein the first backlight device is a backlight device for testing, and the second backlight device is a backlight device provided from an outside source.
